(19) United States
(12) Patent Application Publication
(10) Pub. No.: US 2016/0210228 A1
(43) Pub. Date: Jul. 21, 2016

(54) ASYNCHRONOUS GARBAGE COLLECTION IN A DISTRIBUTED DATABASE SYSTEM

(71) Applicant: HEWLETT PACKARD ENTERPRISE DEVELOPMENT LP, Houston, TX (US)

(72) Inventor: Sebastien Tandel, Porto Alegre Rio Grande do Sul (BR)

(73) Assignee: HEWLETT PACKARD ENTERPRISE DEVELOPMENT LP, Houston, TX (US)

(21) Appl. No.: 14/917,160

(22) PCT Filed: Oct. 30, 2013
(86) PCT No.: PCT/US2013/067493

§ 371 Date: Mar. 7, 2016

(51) Int. Cl. G06F 12/02; G06F 17/30

(52) U.S. Cl. CPC G06F 12/0269; G06F 17/30117; G06F 17/30371

(57) ABSTRACT

A method for asynchronous garbage collection in a distributed database is described herein, The method includes budding a set of candidates for garbage collection and transmitting a garbage collection task to each stage of a pipeline. The method also includes removing data from each stage of the pipeline based on the set of candidates for garbage collection.

### BACKGROUND

A distributed database system may include a number of databases, where portions of each database can reside on various dusters. Each duster may include several servers, where each server can own a portion of the databases. The system may receive updates to the database as users of the system access, modify, delete, or rearrange the data contained in each database. A distributed database system may create different versions of a database in response to changes to the database. The different versions of a database may be referred to as generations of the database.

### BRIEF DESCRIPTION OF THE DRAWINGS

Certain examples are described in the following detailed description and in reference to the drawings, in which:

FIG. 1 is a block diagram of a system including a processing pipeline;

FIG. 2 is a block diagram of a computing device that enables asynchronous garbage collection in a distributed database system;

FIG. 3 is a process flow diagram for asynchronous garbage collection in a distributed database system;

FIG. 4 is a process flow diagram for asynchronous garbage collection in a distributed database system; and

FIG. 5 is a block diagram showing tangible, non-transitory, computer-readable media that enables garbage collection in a distributed database system.

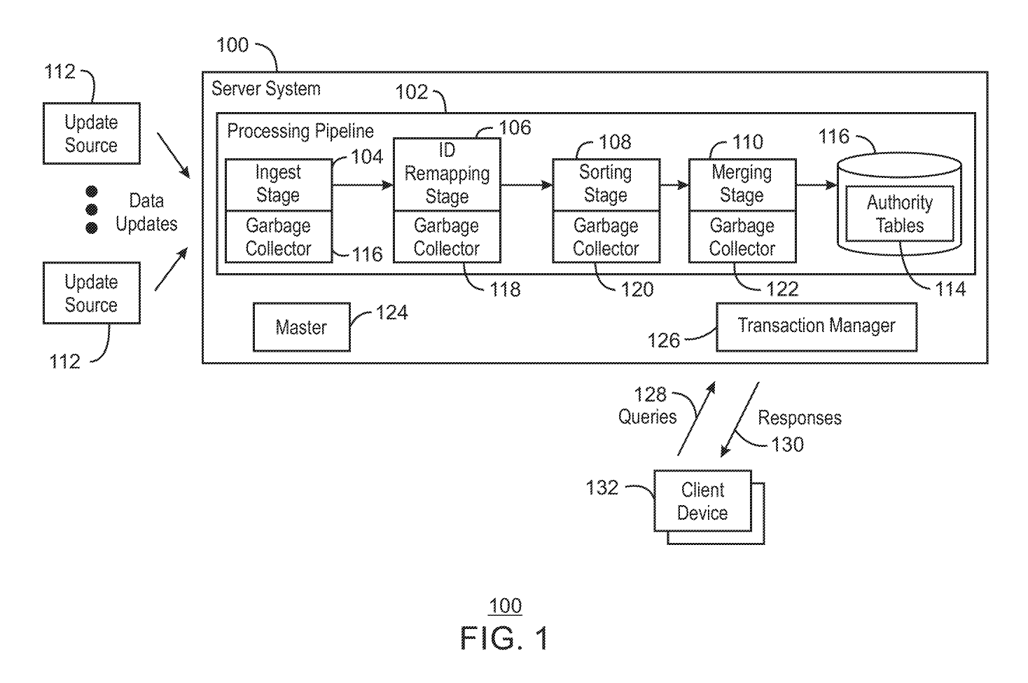

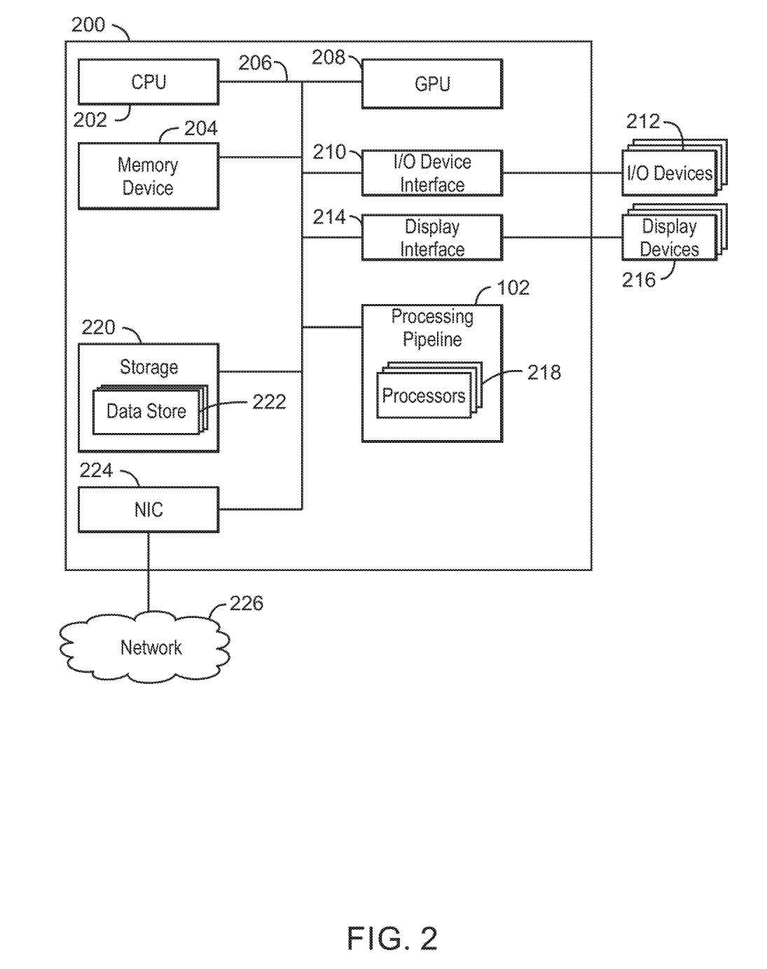

The same numbers are used throughout the disclosure and the figures to reference like components and features. Numbers in the 100 series refer to features originally found in FIG. 1; numbers in the 200 series refer to features originally found in FIG. 2; and so on.

### DETAILED DESCRIPTION OF SPECIFIC EXAMPLES

As discussed above, a distributed database may run on dusters that can be composed of several tens of servers. Each server may store all or some part of the databases. Databases may be designed with a share nothing concept in mind, such that the servers do not maintain any state information regarding the distributed database system. In such a scenario, the distributed database system is coordinated by a Master. Each version of the database may be referred to as a generation. Once a new generation of a database is ready to be queried, the older generation is a candidate to be garbage collected. In some cases, garbage collection is the deletion or removal of old information from the distributed database system. However, the old generation of a database may be immune to garbage collection for data durability and safety reasons. Moreover, a database may be immune to garbage collection when there is an ongoing transaction running on the older generation of the database.

Embodiments described herein enable asynchronous garbage collection in a distributed database system. In embodiments, candidate generations for garbage collection are selected when the generations of data no longer contribute to the data durability or safety of the system. The garbage collection occurs in a share nothing architecture, and the garbage collector results in a small footprint across the overall system. Accordingly, data durability and the safety of the data are optimized at a reduced cost when compared to using a specific garbage collector method. Further, storage resources may be freed resulting in more efficient use of storage systems. The Master may determine the specific generations of the database that may be garbage collected, and the Master may also coordinate garbage collectors that run on each server of the duster.

FIG. 1 is a block diagram of a system 100 including a processing pipeline 102. The processing pipeline 102 includes that has an ingest stage 104, an ID (identifier) remapping stage 106, a sorting stage 108, and a merging stage 110. Data updates from various update sources 112 are provided to the server system 100 for processing by the processing pipeline 102. Examples of the update sources 112 include various machines that can store data within an organization, where the machines can include desktop computers, notebook computers, personal digital assistants (PDAs), various types of servers (e.g., file servers, email servers, etc.), or other types of devices. Although specific stages of the processing pipeline 102 are depicted in FIG. 1, it is noted that in different embodiments alternative stages or additional stages can be provided in the processing pipeline 102. Each stage of the pipeline is independent from the other stages. Additionally, each stage of the pipeline may run on different, independent servers. The actions and tasks of each stage is in the pipeline is orchestrated by a master process, referred to as the Master.

The ingest stage 104 of the processing pipeline 102 batches (collects) incoming updates data updates from update sources 112, Data processed and stored in the server system 100 may include various types of metadata, files, emails, video objects, audio objects, and so forth. The updates may be additions, deletions, or rearrangements of the data. In some embodiments, the incoming updates are batched into a data structure. In some cases, the data structure is a self-consistent update (SCU). An SCU is a batch of updates, where the batch is a single atomic unit and is not considered durable until all the individual updates in the SCU are written to storage. Accordingly, all updates of an SCU are applied or none of the updates of an SCU are applied. Data updates in any one SCU are isolated from data updates in another SCU. In some embodiments, an unsorted SCU is durable, which means that the updates of the SCU are not lost upon some error condition or power failure of the server system 100.

The batched updates are provided to the ID remapping stage 106, which transforms the initial, temporary, IDs of the batched updates into global IDs. Effectively, the ID remapping stage 106 maps an ID in a first space to an ID in a second space. In some embodiments the second space is a global space that provides a single, searchable ID space. The initial, temporary IDs used by the ingest stage 104 are assigned to each unique entity (for example, file names) as those entities are processed. ID's are used in place of relatively large pieces of incoming data such as file path names, which improves query and processing times and reduces usage of storage space. In addition, in embodiments where the ingest stage 104 is implemented with multiple processors, the temporary Ds generated by each of the processors can be remapped to the global ID space. In this manner, the processors of the ingest stage 104 do not have to coordinate with each other to ensure generation of unique IDs, such that greater parallelism can be achieved. In some cases, the term processor can refer to an individual central processing unit (CPU) or to a computer node.

The remapped updates are provided to the sorting stage 108, which sorts the remapped updates by one or more keys to create a sorted batch of updates that contains one or more searchable indexes. In some embodiments, the batched updates include update tables, and the update tables are sorted according to one or more keys to create one or more searchable indexes.

The merging stage 110 combines individual sorted batch of updates into a single set of authority tables 114 to further improve query performance. In some cases, an authority table 114 refers to a repository of the data that is to be stored by the server system 100, where the authority table 114 is usually the table that is searched in response to a query for data. In some embodiments, multiple updates from one or more of the update sources 112 can be batched together into a batch that is to be atomically and consistently applied to an authority table 114 stored in a data store 116 of the server system 100. The data store 116 can store multiple authority tables 114, in some embodiments. More generally, the authority tables 114 are referred to as data tables. In some cases, a database is a collection of data tables.

In accordance with some embodiments, the various processing stages 104, 106, 108, and 110 of the processing pipeline 102 are individually and independently scalable, Each stage of the processing pipeline 102 can be implemented with a corresponding set of one or more processors, where a “processor” can refer to an individual CPU or to a computer node, Parallelism in each stage can be enhanced by providing more processors. In this manner, the performance of each of the stages can be independently tuned by implementing each of the stages with corresponding infrastructure. Note that in addition to implementing parallelism in each stage, each stage can also implement pipelining to perform corresponding processing operations.

The updates to the distributed database system may be implemented as immutable files. In some cases, a specific generation of a database is composed of the authority tables and all the updates in each stage of the pipeline, each update related to a specific logical database. The specific generation is used for transactions at a point in time. Particularly, when a transaction starts the Transaction Manager will decides which generation to use. The same generation will be used throughout the transaction. A distributed database, such as ExpressQuery, can guarantee consistency of the generation because that generation will not be updated, because a generation is composed of immutable files. In this manner, using a lock can be avoided since ExpressQuery uses a new set of files for a new generation. Indeed, when updating the data into some tables, the whole set of tables is generated again, avoiding any lock contention. In some cases, lock contention is a conflict that is the result of several processes requiring an exclusive access to the same resources. Since locks are not used in the present techniques, there is no contention. However, some additional storage space is used as a result of the data replication when generating a new set of tables.

For data durability and safety purposes of the database, each stage of the pipeline keeps the updates and data saved to storage. In this manner, complete generations of the database may be provided at various points in time at each stage of the pipeline. Further, the intermediary data found at each stage of the processing pipeline enables system recovery in the event of corrupt data. In some cases, it is useful to keep some older generations of the database for recovery from potential corruptions.

Each of the ingest stage 104, the ID remapping stage 106, the sorting stage 108, and the merging stage 110 includes a garbage collector thread. Accordingly, the ingest stage 104 includes a garbage collector thread 116, the ID remapping stage 106 includes a garbage collector thread 118, the sorting stage 108 includes a garbage collector thread 120, and the merging stage 110 includes a garbage collector thread 122. The garbage collector threads 116, 118, 120, and 122 do not maintain a state of the distributed database system, and do not decide on information to be deleted. A Master 124 sends tasks to each of the garbage collector threads 116, 118, 120, and 122. The garbage collector threads 116, 118, 120, and 122 then execute the task, which indicates the data to be deleted. In some embodiments, the Master 124 works with a Transaction Manager 126 to select the correct set of data to garbage collect at each stage. The Transaction Manager 126 may be used to identify the data currently involved in an active transaction.

In some embodiments, an active transaction is a query 128 or a response 130 to the server system 100. One or more client devices 132 can submit queries 128 to the server system 100. The server system 100 responds to the queries 128 with responses 130 that are provided back to the one or more client devices 130. Note that the client devices 130 may or may not have devices in common with the update sources 112. To process a query from a client device 130, the server system 100 can access just the authority tables 114, or alternatively, the server system 100 has the option of selectively accessing one or more of the processing stages 104, 106, 108, and 110 in the processing pipeline 102. Thus, any updates or data involved in the query 128 or the response is an active transaction.

FIG. 2 is a block diagram of a computing device 200 that enables asynchronous garbage collection in a distributed database system. The computing device 200 may be, for example, a laptop computer, desktop computer, tablet computer, mobile device, or server, among others. The computing device 200 may include a central processing unit (CPU) 202 that is configured to execute stored instructions, as well as a memory device 204 that stores instructions that are executable by the CPU 202. The CPU may be coupled to the memory device 204 by a bus 206. Additionally, the CPU 202 can be a single core processor, a multi-core processor, a computing duster, or any number of other configurations.

The memory device 204 can include random access memory (RAM), read only memory (ROM), flash memory, or any other suitable memory systems. For example, the memory device 204 may include dynamic random access memory (DRAM). The computing device 200 may also include a graphics processing unit (GPU) 208. As shown, the CPU 202 may be coupled through the bus 206 to the GPU 208. The GPU 208 may be configured to perform any number of graphics operations within the computing device 200. For example, the GPU 208 may be configured to render or manipulate graphics images, graphics frames, videos, or the like, to be displayed to a user of the computing device 200.

The CPU 202 may be connected through the bus 206 to an input/output (I/O) device interface 210 configured to connect the computing device 200 to one or more I/O devices 212. The I/O devices 212 may include, for example, a keyboard and a pointing device, wherein the pointing device may include a touchpad or a touchscreen, among others. The I/O devices 212 may be built-in components of the computing device 200, or may be devices that are externally connected to the computing device 200.

The CPU 202 may also be linked through the bus 206 to a display interface 214 configured to connect the computing device 200 to display devices 216. The display devices 216 may include a display screen that is a built-in component of the computing device 200. The display devices 216 may also include a computer monitor, television, or projector, among others, that is externally connected to the computing device 200.

Moreover, the computing device 200 may be connected through bus 206 to a processing pipeline 102. The processing pipeline 102 may include one or more processors 218. In embodiments, the processing pipeline 102 includes one processor 218 for each stage of the processing pipeline, as described with respect o FIG. 1.

The computing device also includes a storage device 220. The storage device 220 is a physical memory such as a hard drive, an optical drive, a thumbdrive, an array of drives, or any combinations thereof. The storage device 220 may also include remote storage drives. The storage device 220 includes any number of data stores 222 that store data from a distributed database. The data stores 222 may include several generations of the databases within the data store 222. The data store 222 may also store intermediate data from each stage of the processing pipeline 102. As discussed herein, the garbage collector thread of each stage of the processing pipeline may be used to delete data from the data store 222.

The computing device 200 may also include a network interface controller (NIC) 224 may be configured to connect the computing device 200 through the bus 206 to a network 226. The network 226 may be a wide area network (WAN), local area network (LAN), or the Internet, among others.

The block diagram of FIG. 2 is not intended to indicate that the computing device 200 is to include all of the components shown in FIG. 2. Further, the computing device 200 may include any number of additional components not shown in FIG. 2, depending on the details of the specific implementation.

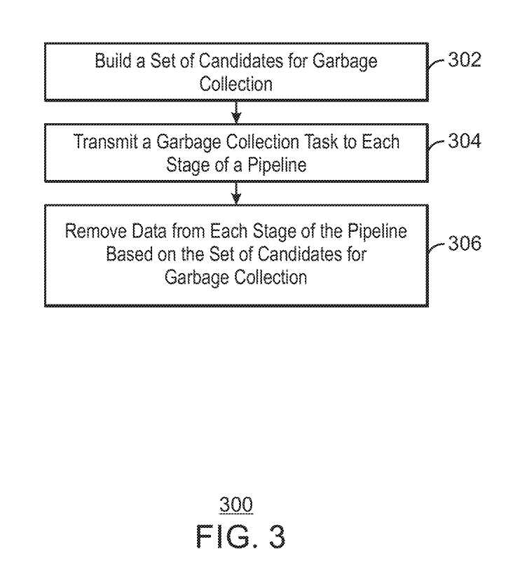

FIG. 3 is a process flow diagram 300 for asynchronous garbage collection in a distributed database system. In some embodiments the distributed database system may be an ExpressQuery database. Moreover, the distributed database system may be designed using a share nothing concept, where each server does not store state information regarding the distributed database system.

At block 302, a set of candidates for garbage collection is built. The set of candidates for garbage collection may be built by the Master. In some cases, the Master is the only process within the distributed database system to store state information that indicates what information is kept on storage and the location of that information.

At block 304, a garbage collection task is transmitted to each stage of a pipeline. The Master may communicate with each stage of the processing pipeline on all servers to transmit a garbage collection task. At block 306, data is removed from each stage of the pipeline based on the set of candidates for garbage collection, A garbage collection thread within each stage of the processing pipeline may be used to execute the garbage collection task and remove the data indicated by the garbage collection task,

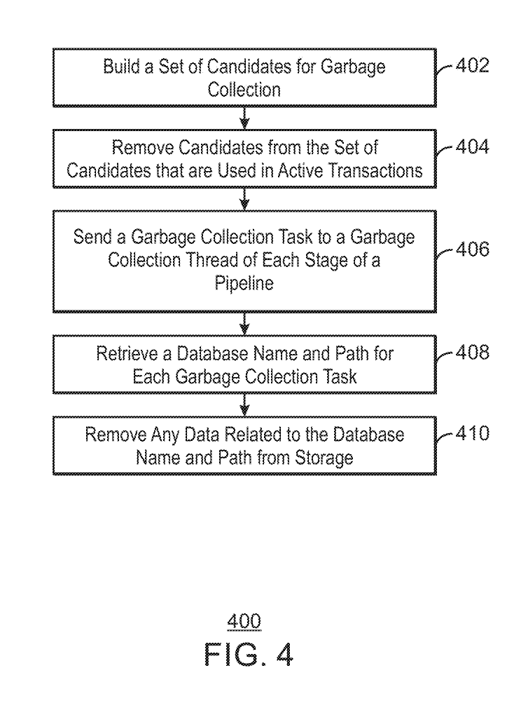

FIG. 4 is a process flow diagram 400 for asynchronous garbage collection in a distributed database system. At block 402, a set of candidates for garbage collection is built. The Master may be used in a share nothing architecture to coordinate processes across the entire system. At block 404, candidates are removed from the set of candidates that are used in active transactions. The Master may be used to filter various generations of databases from the list of generations to be removed. For example, the Master may filter out any generation which is subject to an active transaction. In embodiments, the Master communicates with a Transaction Manager to filter out the generations subject to active transactions, The Master may also filter out generations that are used to ensure data reliability and safety. In this manner, all the queries within a transaction are executed against the same set of files forming the database and the data of the distributed database system is consistent.

At block 406, a garbage collection task is sent to a garbage collection thread of each stage of a pipeline. The Master may communicate with each stage of the processing pipeline on all servers to transmit a garbage collection task. Each stage of the pipeline may then transmit the garbage collection task to its respective garbage collection thread. The garbage collection thread may be referred to as the Garbage Collector. The Garbage Collector runs in parallel with the other tasks performed at each stage of the pipeline. Moreover, the Garbage Collector does not block the Master from orchestrating any further task at any other stage. Additionally, the Garbage Collector does not block any stage of the pipeline. As a result, the Garbage Collector does not have a performance impact on the distributed database system.

At block 408, a database name and path is retrieved for each garbage collection task. The database name and path may be used to locate the data subject to the Garbage Collection task. At block 410 any data related to the database name and path is removed from storage.

The process flow diagrams in FIG. 3 and FIG. 4 are not intended to indicate that each of the process flow diagram 300 and the process flow diagram 400 are to include all of the components shown in FIG. 3 and FIG. 4. Further, the process flow diagram 300 and the process flow diagram 400 may include fewer or more blocks than what is shown, and blocks from the process flow diagram 300 may be included in the process flow diagram 400, and vice versa, depending on the details of the specific implementation.

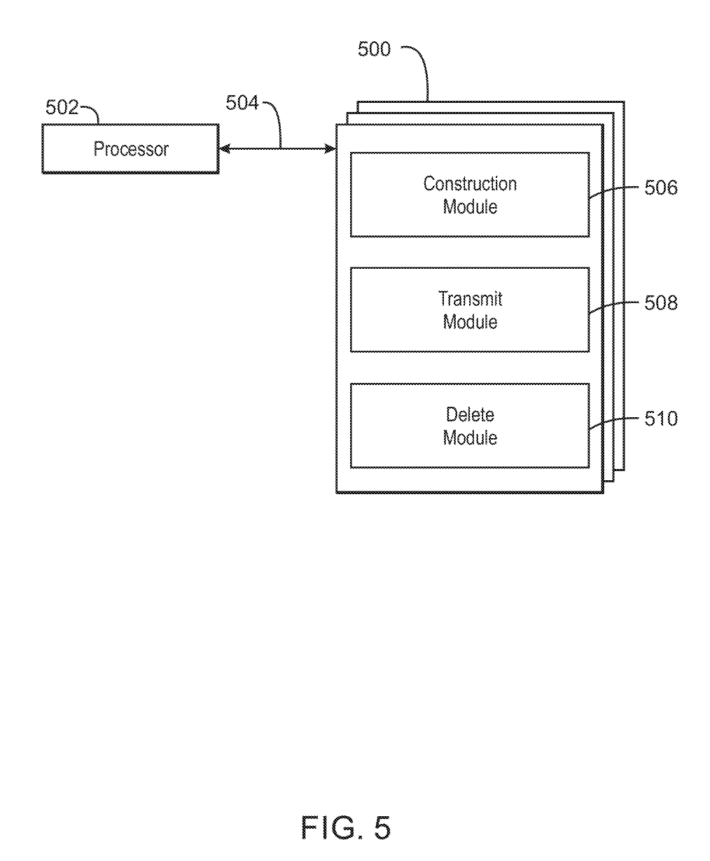

FIG. 5 is a block diagram showing tangible, non-transitory, computer-readable media 500 that enables garbage collection in a distributed database system, The computer-readable media 500 may be accessed by a processor 502 over a computer bus 504. Furthermore, the computer-readable media 500 may include code to direct the processor 502 to perform the steps of the current method.

The various software components discussed herein may be stored on the tangible, non-transitory, computer-readable media 500, as indicated in FIG. 5. For example, a construction module 506 may be configured to build a set of candidates for garbage collection. In some cases, the Master may be used to filter various generations of databases from the list of generations to be removed, A transmit module 508 may be configured to transmit a garbage collection task. In examples, the garbage collection task is sent to each stage of the pipeline by the Master, and each stage then sends the garbage collection task to its garbage collection thread. A delete module 510 may be configured to remove data from each stage of the pipeline based on the set of candidates for garbage collection.

It is to be understood that FIG. 5 is not intended to indicate that all of the software components discussed above are to be included within the tangible, non-transitory, computer-readable media 500 in every case. Further, any number of additional software components not shown in FIG. 5 may be included within the tangible, non-transitory, computer-readable media 500, depending on the specific implementation. For example, a licensing may be used to enable the modification of a capping zone according to a power capping strategy.

While the present techniques may be susceptible to various modifications and alternative forms, the exemplary examples discussed above have been shown only by way of example, It is to be understood that the technique is not intended to be limited to the particular examples disclosed herein. indeed, the present techniques include all alternatives, modifications, and equivalents falling within the true spirit and scope of the appended claims.

What is claimed is:

1. A method for asynchronous garbage collection in a distributed database system, comprising:
building a set of candidates for garbage collection;
transmitting a garbage collection task to each stage of a pipeline; and
removing data from each stage of the pipeline based on the set of candidates for garbage collection and the garbage collection task, wherein the garbage collection task does not block any stage of the pipeline from execution.

2. The method of claim 1, wherein a candidate used in active transactions is removed from the set of candidates for garbage collection prior to removing data from each stage of the pipeline.

3. The method of claim 1, wherein the garbage collection task is transmitted to a garbage collection thread of each stage of the pipeline.

4. The method of claim 1, wherein a database name and a path of data to be removed is retrieved for each transmitted garbage collection task.

5. The method of claim 1, wherein the garbage collection task is processed by a single thread running in each of a number processes of each stage of the pipeline.

6. The method of claim 1, wherein each stage of the pipeline does not maintain any state of the database and does not determine what data is to be removed.

7. A system for asynchronous garbage collection in a distributed database:
a processing pipeline having a plurality of processing stages, wherein each processing stage is separate from the other processing stages;
a storage device that stores instructions, the storage device comprising processor executable code that, when executed by each processing stage, is configured to:
receive a garbage collection task from a master;
send the garbage collection task to a garbage collection thread within each processing stage;
retrieve a database name and a path for each set of data to be deleted based on the garbage collection task; and
delete the set of data from a storage location.

8. The system of claim 7, wherein the master builds a set of candidates to garbage collect for generations of the database.

9. The system of claim 7, wherein the master filters out the generation for which there are running transactions.

10. The system of claim 7, wherein the master and a transaction manager coordinate a set of candidates to garbage collect by filtering out the candidates that have a running transaction based on information from the transaction manager.

11. The system of claim 7, the garbage collection task includes information such that the garbage collection thread of each processing stage can identify the data to be deleted from storage.

12. The system of claim 7, wherein the garbage collector thread of each processing stage is executed in parallel with the garbage collector threads of other processing stages.

13. The system of claim 7, wherein the garbage collector thread does not block any processing by the master or any processing stage.

14. The system of claim 7, wherein the garbage collection task is added to a queue of the garbage collection thread when it is sent to the garbage collection thread.

15. A tangible, non-transitory, computer-readable medium comprising code to direct a processor to:
construct a set of candidates for garbage collection;
transmit a garbage collection task to each stage of a pipeline: and
delete data from each stage of the pipeline based on the set of candidates for garbage collection.
